(19) United States
(12) Patent Application Publication
(10) Pub. No.: US 2006/0150345 A1
(43) Pub. Date: Jul. 13, 2006

(54) New anionic coloring agents to dye leather, paper, cardboard and textile substrates: mixtures of coloring agents including these new products, and substrates dyed using the above coloring agents

(76) Inventor: Jorge Mazza, Buenos Aires (AR)

Correspondence Address: DARBY & DARBY P.C., P. O. BOX 5257, NEW YORK, NY, 10150-5257, US

(21) Appl. No.: 10/881,342

(22) Filed: Jun. 30, 2004

Related U.S. Application Data
(63) Continuation-in-part of application No. 10/023,962, filed on Dec. 18, 2001, now abandoned.

(30) Foreign Application Priority Data
Dec. 18, 2000 (AR) P 00 01 06734

(51) Int. Cl. C09B 67/00

(52) U.S. Cl. 8/528

(57) ABSTRACT

Anionic coloring agents comprising at least one spacer-arm bounded to their chemical structure, wherein said anionic coloring agents have the following formula: C_{A}—R_{SA}, wherein, C_{A} is an anionic coloring agent comprising at least a chromophore group selected from the group consisting of azo, anthraquinone, formazane, dioxazine, phthalocyanine and/or sulphur; and R_{SA} is said spacer-arm, which has the following chemical structure: —X—R-Z, wherein, X is a chemical bond or a group having the formula —S(O)ₙ, wherein n is 1 or 2; or a —NR₁— group, wherein R₁ is a hydrogen atom or a linear or branched C₁-C₁₀ alkyl group; R is a linear or branched C₁-C₁₀ alkylene group; Z is a —NR₂R₃, —S—SO₃R₄, or —SO₃R₅ group, wherein, R₂, R₃, R₄ and R₅ are, independently, a hydrogen atom or a linear or branched C₁-C₁₀ alkyl group; or, Z is a —NR₆—(CH₂)ₘ—W group, wherein, R₆ a hydrogen atom, a linear or branched hydroxy C₁-C₁₀ alkyl group, or a linear or branched C₁-C₁₀ alkyl group; m is an integer from 1 to 10; and W is a —COOR₇, —CONR₈R₉, —SO₃H, —S—SO₃H, —CN, —SO₃R₁₀, or —S—SO₃R₁₁ group; wherein, R₇, R₈, R₉, R₁₀ or R₁₁ are, independently, a hydrogen atom or a linear or branched C₁-C₁₀ alkyl group; provided that when X is a —NR₁— group, and Z is a —NR₂R₃ group, then R₁, R₂ y R₃ cannot be simultaneously a hydrogen atom. The invention also refers to coloring compositions, which comprise at least one anionic coloring agent of the formula: C_{A}—R_{SA}, wherein, C_{A} and R_{SA} are as described above, and an eventual suitable carrier; and coloring compositions comprising at least two coloring agents, wherein at least one of said coloring agents is an anionic coloring agent as described above, and an eventual suitable carrier. Moreover, the invention reveals the use of the anionic coloring agents and coloring compositions as described above to dye cotton, nylon, wool, regenerated cellulose, leather, and cardboard and paper substrates; and the above dyed substrates. The introduction of spacer-arms in the chemical structure of anionic coloring agents leads to modified anionic coloring agents, which differ from the known coloring agents in their dying properties such as strength, tone and affinity, due to fixation modifications onto the substrate to be dyed.

### BACKGROUND OF THE INVENTION

Since the time when synthetic organic coloring agents were discovered at the end of the XIXth century, they have been developed surprisingly. It is estimated that today there are more than 10.000 coloring agents which are or else have been used for industrial applications. It is to be remembered that the main application of these products comprises coloring a number of substances and materials of different origin, which without said coloring would not have such a pleasant appearance.

The discovery of synthetic organic coloring agents, and in particular of those having bright tones and which are cheap, has brought about a real social revolution, improving color, the general aspect and the warmth of our environment. The world around us has changed for the better since the moment said agents appeared.

It should be observed that, before synthetic organic agents were discovered, bright colors were obtained from very high cost natural colors, whose production was, moreover, highly polluting. Due to their high cost, applications used to be limited, and bright colors (bishop's purple, Tiro's purple) were then only an exception for grey and ocher, which were commonly found in daily life.

Synthetic organic colors are used to color a large number of substrates having different compositions: plastics, textile materials, paper, leather, paints, printing inks, etc.

Each substrate has a particular group of coloring agents. These, in turn, have either chemical groups or functions, which are responsible for the color, which are called “chromophores”. The most common ones have an azoic, anthraquinonic, formazanic, dioxacinic or ftlacianinic structure, etc. According to the complete molecular structure of the coloring agent, and not only on the structure of the chromophore, coloring agents can be classified as direct, acid, reactive, disperse, and organic pigments.

As mentioned above, there are specific coloring groups for each substrate. Thus, for example, the best coloring agents to dye cotton fibers are totally different from those used to dye woolen fibers, or acetate or polyester fibers. And, of course, they are totally different from those used to color polyethylene, PVC or polyurethane films.

Another variable to be taken into account is the color desired. For each substrate, each different color derives from one or several chemical structures and chromophores which can be different from those that create other colors.

Consequently, there are, hundreds of different possibilities which, in turn, justify the need for further and constant research in this field.

As time went by, coloring agents were improved in order to enhance their properties as regards applications on traditional substrates, and also to adapt them to the new substrates that appeared later on.

The hundreds of new patents that have been issued in the last decades are substantial evidence of permanent research and development in this field. Said patents are related, on the one hand, to the search for new chemical structures and families for new coloring agents, and also to the modification of the already existing structures, in order to enhance some of their properties.

The most important properties may vary according to the composition and structure of the substrate on which the coloring agents will be applied, but some of them, such as dye yield, easiness of application and different degrees of strength (under the effect of light, bleeding in different materials, etc.), are always fundamental.

All these properties are related, in one way or another, to one fundamental property: the degree of fixation of the coloring agent on the substrate. This is vital, and there are dozens of patents whose main or only object comprises improving the fixation of a certain coloring agent on a given substrate.

For example, special reactive coloring agents to dye cotton are a particular case. A better fixation produces not only deeper shades of color, improves properties and degrees of strength, but also allows the cleaning of the coloring agent that has not been fixed. Moreover, it has an ecological advantage, that is, it generates effluents which are less colored.

The same applies in the case of special coloring agents for leather, with one more variable: the coloring agent penetrates more or less depending on the thickness of the leather to be dyed. In brief: variation in fixation degrees of the coloring agent on a certain substrate represents habitually a change in some of the properties of said coloring agent once it has been fixed.

The applicant has been working and doing research for many years in order to develop new synthetic coloring agents, among them, several specific anionic coloring agents for the purification of proteins, such as those described and claimed in U.S. Pat. No. 5,597,485 and U.S. Pat. No. 5,876,597. The chromophores of said coloring agents are azo, anthraquinone, formazane, dioxazine, phthalocyanine and/or sulphur

A specific development related to both patents is the use of “spacer arms” in the structure of each coloring agent, in order to enhance the fixation and selectivity of each coloring agent on proteins, which is particularly interesting in absorption chromatography techniques and in dying processes in general.

Said spacer-arms are radicals or ordinary chemical groups bound to the molecules of coloring agents which modify some of their properties. One specific group of said spacer-arms are aliphatic chains, particularly hydrocarbonated chains including between 1 and 10 carbon atoms.

A novel aspect, also disclosed in said patents, is related to the discovery that the build-up of small quantities of coloring agents with spacer arms carried in coloring agents without said arms, improves the fixation of said carrier agents.

In this aspect, it is considered that the coloring agents modified by the inclusion of said spacer-arms, behave as catalysts for the fixation reactions of coloring agents which do not comprise said spacer arms.

Definitions

In the text that follows, the references to “spacer arms”, correspond to either straight or branched C₁-C₁₀ alkylene chains, which carry polar terminal groups, bound to the structure of the coloring agent.

### ABSTRACT OF THE INVENTION

Anionic coloring agents are an object of this invention, and they are characterized in that they comprise at least one spacer arm bound to the structure of said coloring agents.

Therefore, this invention comprises anionic coloring agents comprising at least a spacer-arm in their chemical structure, wherein said anionic coloring agents have the following formula:
C_{A}—R_{SA}
wherein:

C_{A} is an anionic coloring agent comprising at least a chromophore group selected from the group consisting of azo, anthraquinone, formazane, dioxazine, phthalocyanine and/or sulphur; and

R_{SA} is said spacer-arm, which has the following chemical structure:
—X—R-Z
wherein,

X is a chemical bond or a group having the formula —S(O)ₙ, wherein n is 1 or 2; or a —NR₁— group, wherein R₁ is a hydrogen atom or a linear or branched C₁-C₁₀ alkyl group;

R is a linear or branched C₁-C₁₀ alkylene group;

Z is a —NR₂R₃, —S—SO₃R₄, or —SO₃R₅ group, wherein, R₂, R₃, R₄ and R₅ are, independently, a hydrogen atom or a linear or branched C₁-C₁₀ alkyl group; or,

Z is a —NR₆—(CH₂) m —W group, wherein,

R₆ a hydrogen atom, a linear or branched hydroxy C₁-C₁₀ alkyl group, or a linear or branched C₁-C₁₀ alkyl group;

m is an integer from 1 to 10; and

W is a —COOR₇, —CONR₈R₉, —SO₃H, —S—SO₃H, —CN, —SO₃R₁₀, or —S—SO₃R₁₁ group; wherein, R₇, R₈, R₉, R₁₀ or R₁₁ are, independently, a hydrogen atom or a linear or branched C₁-C₁₀ alkyl group;

provided that when X is a —NR₁— group, and Z is a —NR₂R₃ group, then R₁, R₂ y R₃ cannot be simultaneously a hydrogen atom.

Another object of this invention includes coloring compositions, which comprise at least one anionic coloring agent of the formula:
C_{A}—R_{SA}
wherein,

C_{A} and R_{SA} are as described above, and an eventual suitable carrier; and coloring compositions comprising at least two coloring agents, wherein at least one of said coloring agents is an anionic coloring agent as described above, and an eventual suitable carrier.

Another object of this invention includes the use of the anionic coloring agents as described above to dye cotton, nylon, wool, regenerated cellulose, leather, and cardboard and paper substrates.

Another object of present invention refers to cotton, nylon, wool, regenerated cellulose, leather, cardboard and paper substrates dyed with the anionic coloring agents as described above.

### DETAILED DESCRIPTION OF THE INVENTION

The present invention is based on the discovery that the introduction spacer arms in the molecular structure of anionic coloring agents as defined herein, leads to other anionic coloring agents which are different as regards some dyeing property/ies; or for example: strength (intensity or the coloring power, tone, affinity, etc.

Said replacement, in its broader aspect, constitutes a novel application for the modification of anionic coloring agents already revealed in the previous art as synthesis of new coloring agents. Therefore, the present invention allows the favorable modification of the properties of coloring agents already known, so as to produce and synthesize new anionic coloring agents.

Supposedly, the variation of properties is due to a variation in the fixing of the coloring agent on the substrate subject of coloring. Therefore, it is considered that these new molecules, comprising a new traditional coloring agent including one or more of the spacer-arms herein defined, as new coloring substances, which in some cases may include properties and degrees of strength which make them different from the coloring agents traditionally used to generate new molecules.

Therefore, new coloring substances are obtained, unknown so far, which are the object of this patent. In particular, these new coloring substances are especially useful to dye fibers or fabrics totally or partially made of cotton, regenerated cellulose, polyester, nylon and wool, or else to dye leather, cardboard or paper substrates.

The anionic coloring agents included in this invention are all those habitually used to color these substrates, that is, acid, direct, reactive or disperse coloring agents.

The chromophores of these coloring agents are azo, anthraquinone, formazane, dioxazine, phthalocyanine and/or sulphur.

The corresponding spacer-arm must be included in the molecule of the original coloring agent, either by means of a chemical reaction or using an organic intermediary including said spacer-arm for the synthesis of the final coloring agent.

It has been found now, and this is the basis for the present invention, that anionic coloring agents, which comprise at least one spacer arm bound to the structure of said coloring agents, develop new properties and degrees of strength when dyeing different substrates.

Therefore, this invention comprises anionic coloring agents comprising at least a spacer-arm in their chemical structure, wherein said anionic coloring agents have the following formula:
C_{A}—R_{SA}
wherein:

C_{A} is an anionic coloring agent comprising at least a chromophore group selected from the group consisting of azo, anthraquinone, formazane, dioxazine, phthalocyanine and/or sulphur; and

R_{SA} is said spacer-arm, which has the following chemical structure:
—X—R-Z
wherein,

X is a chemical bond or a group having the formula —S(O), wherein n is 1 or 2; or a —NR₁— group, wherein R₁ is a hydrogen atom or a linear or branched C₁-C₁₀ alkyl group;

R is a linear or branched C₁-C₁₀ alkylene group;

Z is a —NR₂R₃, —S—SO₃R₄, or —SO₃R₅ group, wherein, R₂, R₃, R₄ and R₅ are, independently, a hydrogen atom or a linear or branched C₁-C₁₀ alkyl group; or,

Z is a —NR₆—(CH₂) m —W group, wherein,

R₆ a hydrogen atom, a linear or branched hydroxy C₁-C₁₀ alkyl group, or a linear or branched C₁-C₁₀ alkyl group;

m is an integer from 1 to 10; and

W is a —COOR₇, —CONR₈R₉, —SO₃H, —S—SO₃H, —CN, —SO₃R₁₀, or —S—SO₃R₁₁ group; wherein, R₇, R₈, R₉, R₁₀ or R₁₁ are, independently, a hydrogen atom or a linear or branched C₁-C₁₀ alkyl group;

provided that when X is a —NR₁— group, and Z is a —NR₂R₃ group, then R₁, R₂ y R₃ cannot be simultaneously a hydrogen atom.

Moreover, the preferable spacer-arms to change the properties of the coloring agents in question, when they are applied to the substrates above mentioned, are included in the following groups:

a) Spacer-arms having the following chemical structure:
NR₁—(CH₂)—NR₄—(CH₂)₂—W
wherein,

R₁ is a hydrogen atom, a linear or branched hydroxy C₁-C₁₀ alkyl group, or a linear or branched C₁-C₁₀ alkyl group;

n is an integer from 1 to 10;

R₆ is a hydrogen atom or a linear or branched C₁-C₁₀ alkyl group;

W is a —COOR₇ group, wherein, R₇ is a hydrogen atom or a linear or branched C₁-C₁₀ alkyl group; —CONH₂; —CN; or —SO₃H.

b) Spacer-arms having the following chemical structure:
NR₁—(CH₂)₂—W
wherein,

R₁ is a hydrogen atom, a linear or branched hydroxy C₁-C₁₀ alkyl group, or a linear or branched C₁-C₁₀ alkyl group; and

Q is a group selected from —S—SO₃R₄, and —SO₃R₅, wherein, R₄ and R₅ are, independently, a hydrogen atom, or a linear or branched C₁-C₁₀ alkyl group.

The alkyl, hydroxy alkyl and alkylene chains of the spacer-arms can be either straight or branched.

The altered coloring agents which are the object of this patent typically include only one spacer arm, but they can also include two or more, either similar or different spacer-arms.

Another object of this invention includes coloring compositions, which comprise at least one anionic coloring agent of the formula:
C_{A}—R_{SA}
wherein,

C_{A} and R_{SA} are as described above, and an eventual suitable carrier.

Moreover, when even a small amount of coloring agent including a spacer-arm is added to a coloring agent or mixture of coloring agents which does not include said spacer-arms, the properties of the mixture are altered.

Therefore, an even another object of the present invention includes the use of the anionic coloring agents as described above to dye cotton, nylon, wool, regenerated cellulose, leather, and cardboard and paper substrates.

In brief: when dyeing fibers or fabrics totally or partially made of cotton, regenerated cellulose, polyester, nylon and/or wool, or when dyeing leather, cardboard or paper substrates, the spacer-arms mentioned above included in the molecule of each coloring agent typically used in the process involved, can alter some properties of the substrate dyed with the typical coloring agent.

Even another object of present invention refers to cotton, nylon, wool, regenerated cellulose, leather, cardboard and paper substrates which have been dyed by means of any conventional dyeing technique, including printing process, using at least one of the anionic coloring agents or coloring compositions as described above.

The following examples, which are included as an illustration only, show how the present invention can be embodied. The references to parts of components, reactive agents, and the like, correspond to parts in weight.

### EXAMPLES

### Example 1

38.3 parts 2-naphthylamine-3,6,8-trisulfonic acid are diazotised as usual, and coupled with 15.2 parts of 3-ureidoaniline previously dissolved in 115 parts of water at 50° C., treated with 30 parts of sodium bicarbonate and ice-cooled at 0-3° C. When the coupling is finished one part of disperser, 140 parts of ice and 19 parts of cyanuric chloride are added, and then stirred for 90 minutes at a pH of 6.5-6.7. Then, the mixture is treated with 18.8 parts of m-phenylendiamine-4-sulfonic acid dissolved in 80 parts of water with sodium hydroxide at a pH of 5.0-7.0, and then ice-cooled at 40° C. The mixture is heated at 35-40° C. and stirred for one hour, maintaining the pH at 6.5-6.7 by adding a 20% solution of sodium carbonate. The monochlorotriazinyl dye obtained, is precipitated by adding a solution of sodium chloride 20% w/v. The dye is filtered and the cake is dissolved in 900 parts of water with sodium hydroxide at pH 7. 28.1 parts of 4-aminophenyl-β-hydroxy-ethylsulphone sulfate ester are mixed in 150 parts of water conditioning the pH at 7 with sodium bicarbonate. To the obtained solution, 13.1 parts of ε-aminocaproic acid are added, previously dissolved in 100 ml of water at pH=7.0 with sodium hydroxide 48%. The mixture is heated at 60° C. and mixed within an hour. 22 parts of concentrated hydrochloric acid are added. The obtained suspension is cooled at 0° C. with ice, and the mixture is diazotised with 7 parts of sodium nitrite added as a solution 30% w/w. The mixture is mixed within 1 hour at 0-3° C. and then the excess of nitrous acid is eliminated with sulfamic acid. The diazo obtained is coupled with the foregoing mixture maintaining the pH between 7 and 8 adding a dilute solution of sodium carbonate. The coloring agent obtained is precipitated with potassium chloride, filtered, and dried.

A reactive coloring agent according to Formula 1 is obtained. This coloring agent is similar to the one mentioned in Example 1, U.S. Pat. No. 5,484,899 shown in Formula 2, except that it includes a spacer-arm.

When this new coloring agent is used on cotton, according to any of the traditional methods, the dyed material obtained exhibits a very good degree of strength and general properties.

### Example 2

13.1 parts of ε-aminocaproic acid are dissolved at a pH 10 in 100 ml of water with sodium hydroxide at 48% and are added on 28.1 parts of 4-aminophenyl-β-hydroxy-ethylsulphone sulfate ester previously dissolved in 150 parts of water at pH 7 with sodium bicarbonate. The mixture is heated at 60° C. and stirred for 1 hour. 22 parts of concentrate hydrochloric acid are added. The obtained suspension is cooled at 0° C. with ice and is diazotised with 7 parts of a solution of sodium nitrite 30%. The mixture is stirred for 1 hour at 0-3° C., and then the excess of nitrous acid is eliminated with sulfamic acid, maintaining the temperature within 0-5° C.

Separately, 31.9 parts of 4-amino-5-hydroxy-2,7-naphthalenedisulfonic acid are dissolved at pH=6.0-6.5 with sodium hydroxide in 100 parts of water, and passed drop-wise on a diazo prepared from 26.3 parts of 4,4′-diaminosulfanilide according to the conventional methods.

Finished the above copulation, the resulting compound is coupled with the foregoing diazo raising the pH at 6.0-6.5 with diluted sodium hydroxide. The mixture is stirred for 4 hours. It is stirred for 10-15 minutes. Then, 10.3 parts of m-phenylenediamine are added, and stirred for 1 hour. The obtained product is heated at 80° C. and precipitated with potassium chloride, filtered and dried.

An acid coloring agent according to Formula 3 is obtained. This coloring agent is similar to the one mentioned in Example 174, DE 2,245,835, shown in Formula 4, except that a spacer-arm is included.

When this new coloring agent is used on leather, according to any of the traditional methods, the dyed material obtained exhibits a very good degree of strength as well as very good general properties.

### Example 3

31.9 parts of 4-amino-5-hydroxy-2,7-naphthalenedisulfonic acid are dissolved in 100 parts of water at a pH of 6.0 with diluted sodium hydroxide. 24.3 parts of 4-aminophenyl-N,N-dimethylpropilenediamineethylsulfone are suspended in 100 parts of water, 12 parts of 10 N hydrochloric acid are added. The slurry obtained is then ice-cooled at 0° C., and diazotised with 7 parts of sodium nitrite as a 30% solution. It is stirred for one hour at 0-3° C., and the excessive nitrous acid is eliminated with sulfamic acid. At a constant temperature of 0-5° C. the solution of 4-amino-5-hydroxy-2,7-naphthalenedisulfonic acid is added drop-wise on the previous diazo, and stirred for 16 hours. Moreover, 26.3 parts of 4,4′-diaminesulfanilide are diazotised according to conventional methods. The diazo obtained is added rapidly to the previous product after being dissolved with sodium hydroxide diluted at a pH of 6.0-6.5 and ice-cooled at 0-1° C. It is then stirred for 10-15 minutes, and then its pH is adjusted to 9.0 with 10% sodium hydroxide. It is stirred for 4 hours. The product thus obtained is treated with 61.5 parts of Sulphur Black 1 previously reduced in 76 parts of water with 31 parts of sodium hydroxide (48% solution) and 15.6 parts of dextrose for 3-5 hours a 90° C., and ice-cooled at 10° C. The coloring agent thus obtained is precipitated with potassium chloride, then filtered and dried.

A coloring agent derived from black to sulphur according to Formula 5 is obtained. This coloring agent is similar to the one mentioned in EP 731,144 shown in Formula 6, except that one of the spacer arms mentioned above is included.

When this new coloring agent is used on leather, according to any of the traditional methods, the dyed material obtained exhibits a very good degree of strength, as well as very good general properties.

### Example 4

13.1 parts of ε-aminocaproic acid are dissolved in 100 ml of water at a pH of 10 with 48% sodium hydroxide and added on 39 parts of 4-sulfatoethylsulfonyl-2-aminophenol-5-sulfonic acid previously suspended in 150 parts of water and taken to a pH of 7 with sodium bicarbonate. It is heated to 60° C., and stirred for one hour. 22 parts of concentrated hydrochloric acid are added. The slurry thus obtained is ice-cooled to 0° C., and diazotised with 7 parts of sodium nitrite as a 30% solution. It is stirred for one hour at 0-3° C., and then the excess nitrous acid is eliminated with sulfamic acid. The diazo thus obtained is coupled with 23.9 parts of 6-amino-4-hydroxy-2-naphthalenesulfonic acid dissolved in 200 parts of water with 20 parts of sodium carbonate, and ice-cooled to 0° C.; the pH must not be under 7.5. Stirring continues for 2 hours. The pH of the slurry thus obtained is adjusted to 5.5 with a sufficient amount of acetic acid; it is treated with 13.8 parts of chromium acetate, and then heated to boiling point until metallization is complete. The product thus obtained is ice-cooled to 0° C.; 22 parts of hydrochloric acid 10 N are added, and diazotised with 7 parts of sodium nitrite. It is stirred for 60-90 minutes at 0-3° C., and then the excess nitrous acid is eliminated with sulfamic acid. Finally, a solution of 8.85 parts of acetoacetanilide is added together with 5.45 parts of m-aminophenol in 100 parts of water with 4 parts of sodium hydroxide. The pH is adjusted to 9.0-9.5 with 10% sodium hydroxide. The coloring agent thus obtained is precipitated with potassium chloride, then filtered and dried.

A metallized acid coloring agent is thus obtained according to Formula 7. This agent is similar to the one mentioned in Example 174, DE 3,805,746 shown in Formula 8, except that one of the spacer arms mentioned above is included.

When this new coloring agent is used on leather, according to any of the traditional methods, the dyed material obtained exhibits a very good degree of strength and general properties.

### Example 5

38.3 parts of 2-naphthylamine-3,6,8-trisulfonic acid are diazotised as usual, and coupled with 15.2 parts of 3-ureidoaniline previously dissolved in 115 parts of water at 50° C., treated with 30 parts of sodium bicarbonate and ice-cooled at 0-3° C. When the coupling is finished one part of disperser, 140 parts of ice and 19 parts of cyanuryl chloride are added, and then stirred for 90 minutes at a pH of 6.5-6.7. Then, the mixture is treated with 18.8 parts of m-phenylendiamine-4-sulfonic acid dissolved in 80 parts of water with sodium hydroxide at a pH of 5.0-7.0, and then ice-cooled at 40° C. The mixture is heated at 35-40° C. and stirred for one hour, maintaining the pH at 6.5-6.7 by adding a 20% solution of sodium carbonate. 11.3 parts of 3-[(2-aminoethyl)amino]propionitrile dissolved in 300 parts of water are added and then heated at 80-85° C. It is stirred for an hour at 80-85° C. The intermediate is then precipitated with hydrochloride acid 10 N at a pH of 1.5 and filtered. The cake is dissolved in 900 parts of water with sodium hydroxide at pH 9 and coupled with 28.2 parts of 4-aminophenyl-β-hydroxy-ethylsulphone sulfate ester diazotised in the usual way. The pH is maintained with a solution of sodium carbonate 20%. The coloring agent obtained is precipitated with potassium chloride and acidifying with hydrochloride acid to pH 1.6, filtered, and resuspended in 760 parts of water, the pH is adjusted to pH 4.7-4.8 with disodium phosphate, and dried.

A reactive coloring agent according to Formula 9 is obtained. This coloring agent is similar to the one mentioned in Example 1, U.S. Pat. No. 5,484,899 shown in Formula 10, except that it includes the above-mentioned spacer-arm.

When this new coloring agent is used on cotton, according to any of the traditional methods, the dyed material obtained exhibits a very good degree of strength and general properties.

### Example 6

38.3 parts of 2-naphthylamine-3,6,8-trisulfonic acid are diazotised as usual, and coupled with 15.2 parts of 3-ureidoaniline previously dissolved in 115 parts of water at 50° C., treated with 30 parts of sodium bicarbonate and ice-cooled at 0-3° C. When the coupling is finished one part of a dispersing agent, i.e. sodium lauryl sulfate, 140 parts of ice and 19 parts of cyanuryl chloride are added, and then stirred for 90 minutes at pH 6.5-6.7. Then, the mixture is treated with 18.8 parts of m-phenylendiamine-4-sulfonic acid dissolved in 80 parts of water with sodium hydroxide at pH 5.0-7.0, and then ice-cooled at 40° C. The mixture is heated at 35-40° C. and stirred for one hour, maintaining the pH at 6.5-6.7 by adding a 20% solution of sodium carbonate. 15.8 parts of 2-aminoethanethiosulfonic acid dissolved in 300 parts of water are added and heated at 80-85° C. and stirred for an hour at 80-85° C. The cake is dissolved in 900 parts of water with sodium hydroxide at pH 9 and coupled with 28.2 parts of 4-aminophenyl-β-hydroxy-ethylsulphone sulfate ester diazotised as usual. The pH is maintained with a 20% solution of sodium carbonate.

The coloring agent obtained is precipitated with potassium chloride acidifying with hydrochloride acid to pH 1.6, filtered, resuspended in 760 parts of water, the pH adjusted to 4.7-4.8 with disodium phosphate, and dried.

A reactive coloring agent according to Formula 11 is obtained. This coloring agent is similar to the one mentioned in Example 1, U.S. Pat. No. 5,484,899 shown in Formula 12, except that it includes the above-mentioned spacer-arm.

When this new coloring agent is used on cotton, according to any of the traditional methods, the dyed material obtained exhibits a very good degree of strength and general properties.

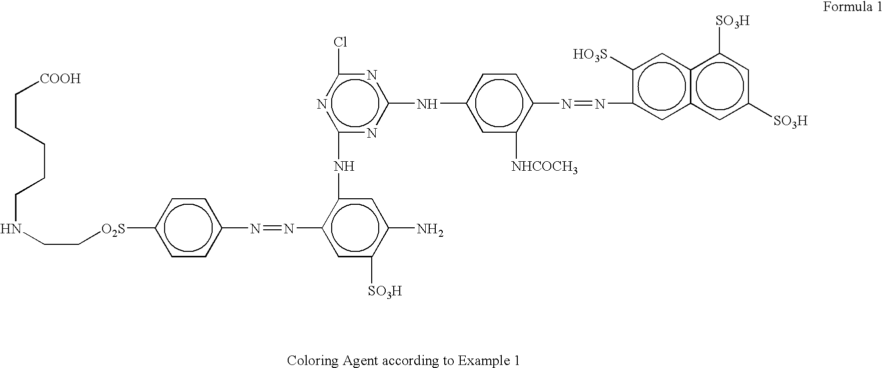

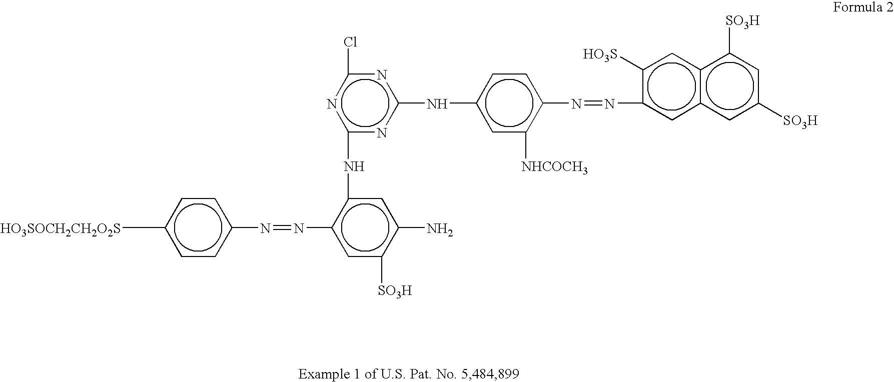

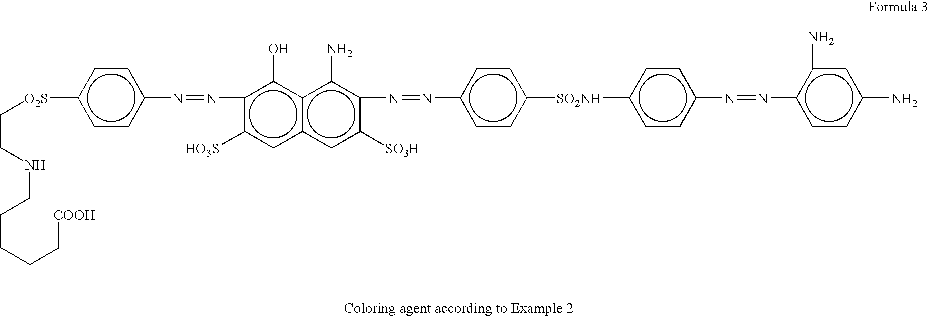

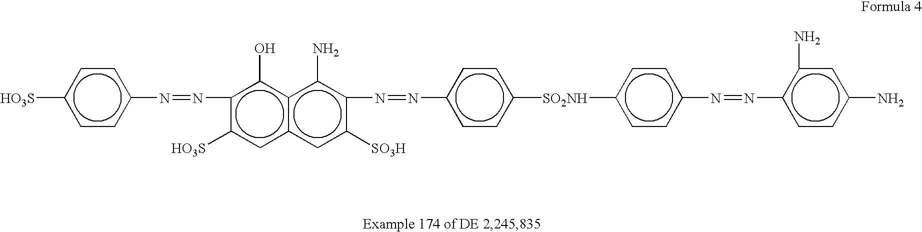

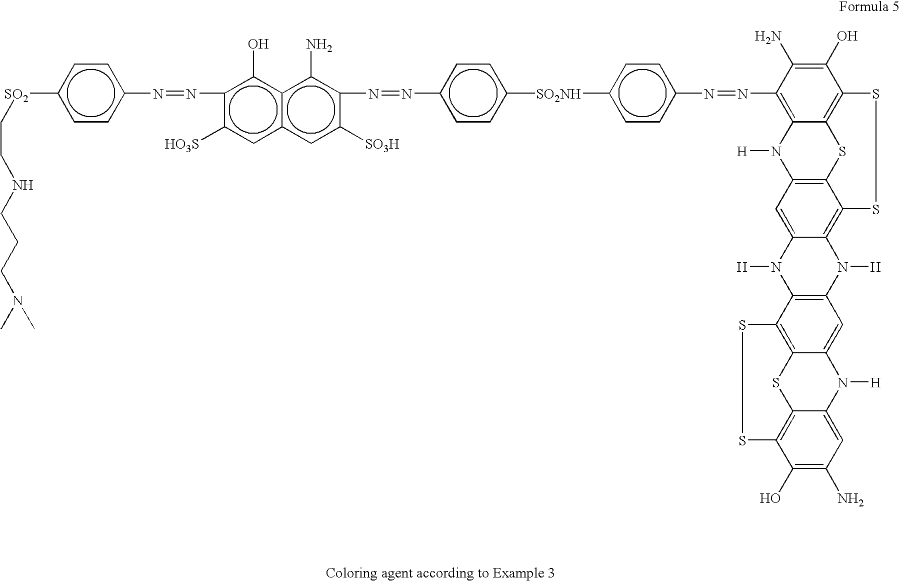

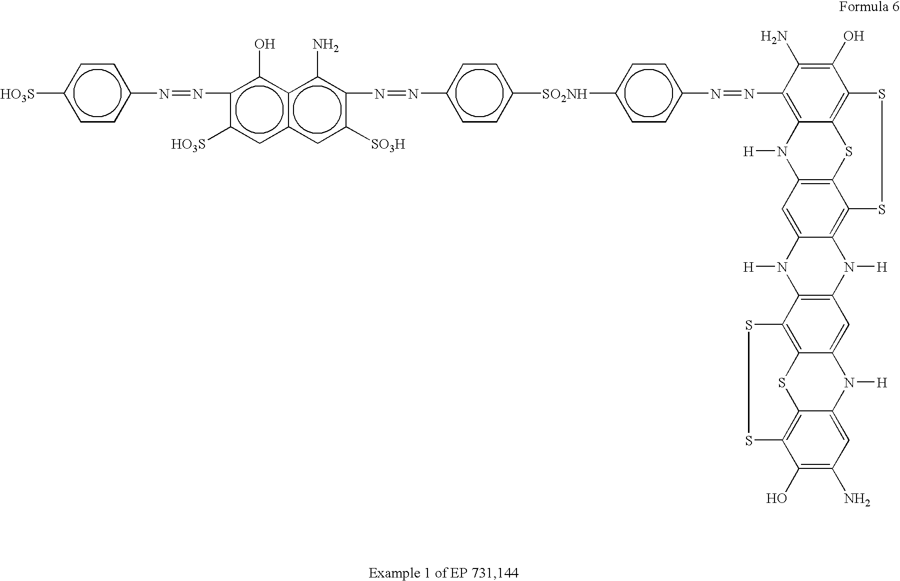

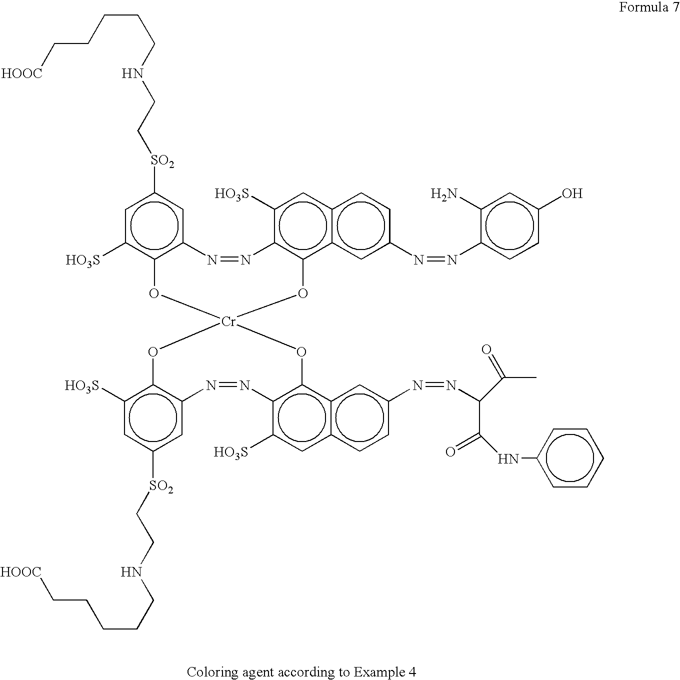

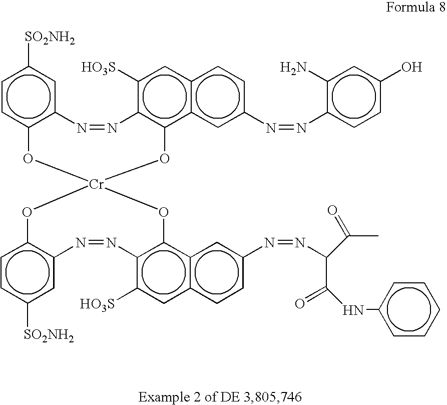

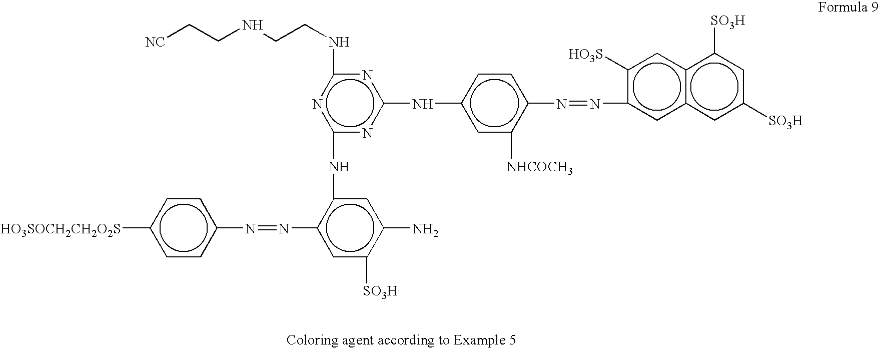

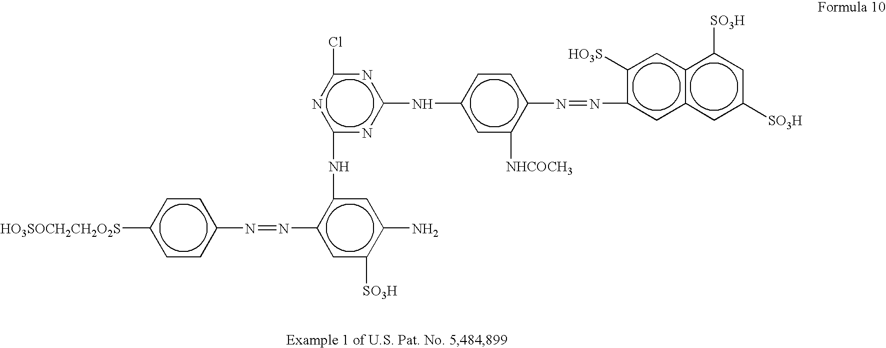

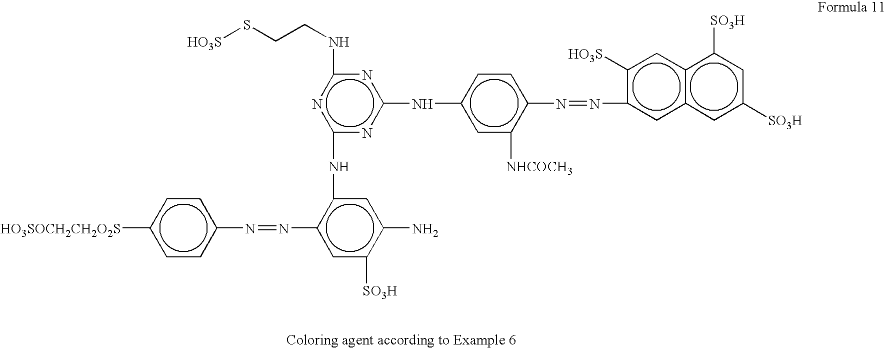

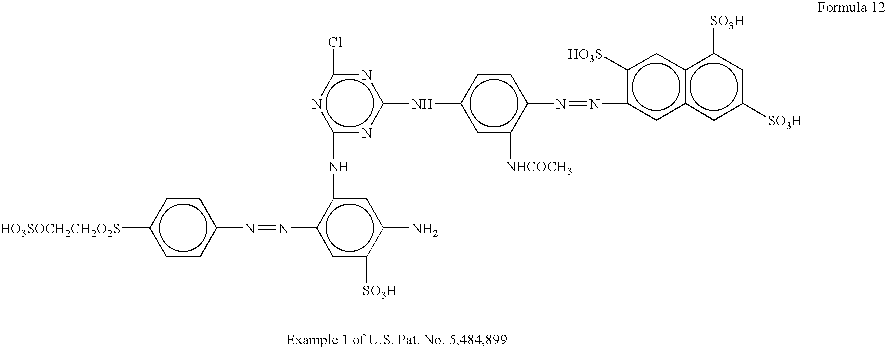

1. Anionic coloring agents comprising at least a spacer-arm in their chemical structure, wherein said anionic coloring agents have the following formula:
C_{A}—R_{SA}
wherein:
C_{A} is an anionic coloring agent comprising at least a chromophore group selected from the group consisting of azo, anthraquinone, formazane, dioxazine, phthalocyanine and/or sulphur; and
R_{SA} is said spacer-arm, which has the following chemical structure:
—X—R-Z
wherein,
X is a chemical bond or a group having the formula —S(O)ₙ, wherein n is 1 or 2; or a —NR₁— group, wherein R₁ is a hydrogen atom or a linear or branched C₁-C₁₀ alkyl group;
R is a linear or branched C₁-C₁₀ alkylene group;
Z is a —NR₂R₃, —S—SO₃R₄, or —SO₃R₅ group, wherein, R₂, R₃, R₄ and R₅ are, independently, a hydrogen atom or a linear or branched C₁-C₁₀ alkyl group; or,
Z is a —NR₆—(CH₂) m —W group, wherein,
R₆ a hydrogen atom, a linear or branched hydroxy C₁-C₁₀ alkyl group, or a linear or branched C₁-C₁₀ alkyl group;
m is an integer from 1 to 10; and
W is a —COOR₇, —CONR₈R₉, —SO₃H, —S—SO₃H, —CN, —SO₃R₁₀, or —S—SO₃R₁₁ group; wherein, R₇, R₈, R₉, R₁₀ or R₁₁ are, independently, a hydrogen atom or a linear or branched C₁-C₁₀ alkyl group;
provided that when X is a —NR₁— group, and Z is a —NR₂R₃ group, then R₁, R₂ y R₃ cannot be simultaneously a hydrogen atom.

2. Anionic coloring agents according to claim 1 comprising at least a spacer-arm in their chemical structure, wherein said spacer-arm is as follows:
NR₁—(CH₂)ₙ—NR₆—(CH₂)₂—W
wherein,
R₁ is a hydrogen atom, a linear or branched hydroxy C₁-C₁₀ alkyl group, or a linear or branched C₁-C₁₀ alkyl group;
n is an integer from 1 to 10;
R₆ is a hydrogen atom or a linear or branched C₁-C₁₀ alkyl group;
W is a —COOR₇ group, wherein, R₇ is a hydrogen atom or a linear or branched C₁-C₁₀ alkyl group; —CONH₂; —CN; or —SO₃H.

3. Anionic coloring agents according to claim 1 comprising at least a spacer-arm in their chemical structure, wherein said spacer-arm is as follows:
NR₁—(CH₂)₂-Q
wherein,
R₁ is a hydrogen atom, a linear or branched hydroxy C₁-C₁₀ alkyl group, or a linear or branched C₁-C₁₀ alkyl group; and
Q is a group selected from —S—SO₃R₄, and —SO₃R₅, wherein, R₄ and R₅ are, independently, a hydrogen atom, or a linear or branched C₁-C₁₀ alkyl group.

4. Coloring compositions comprising at least one anionic coloring agent according to any of the preceding claims, and an eventual suitable carrier.

5. Coloring compositions comprising at least two coloring agents, wherein at least one of said coloring agents is an anionic coloring agent according to any of the preceding claims, and an eventual suitable carrier.

6. Coloring compositions according to claim 5, wherein the anionic coloring agent comprising at least a spacer-arm in its chemical structure is present in at least 1% p/p of the composition.

7. Use of the anionic coloring agents according to claims 1 to 3, for dyeing a substrate selected from fibers or fabrics including cotton, regenerated cellulose, nylon and wool.

8. Use of the anionic coloring agents according to claims 1 to 3, for dyeing a substrate selected from leather, cardboard or paper.

9. Use of the coloring compositions according to claims 4 to 6, for dyeing a substrate selected from fibers or fabrics including cotton, regenerated cellulose, nylon, and wool.

10. Use of the coloring compositions according to claims 4 to 6, for dyeing a substrate selected from leather, cardboard and paper.

11. Dyed substrates which have been dyed using the anionic coloring agents according to claims 1 to 3.

12. Dyed substrates which have been dyed using the coloring compositions according to claims 4 to 6.

13. Dyed substrates which have been dyed by means of any conventional dyeing technique, including printing process, using at least one of the anionic coloring agents according to claims 1 to 3.

14. Dyed substrates which have been dyed by means of any conventional dyeing technique, including printing process, using at least one of the coloring compositions according to claims 4 to 6.
